(19) United States
(12) Patent Application Publication
(10) Pub. No.: US 2018/0320423 A1
(43) Pub. Date: Nov. 8, 2018

(54) DOOR BARRICADE

(71) Applicant: THE JOHNS HOPKINS UNIVERSITY, Baltimore, MD (US)

(72) Inventor: Richard P. Middlestadt, Joppa, MD (US)

(21) Appl. No.: 15/974,034

(22) Filed: May 8, 2018

Related U.S. Application Data
(60) Provisional application No. 62/502,877, filed on May 8, 2017.

(51) Int. Cl. E05C 19/18

(52) U.S. Cl. CPC E05C 19/188

(57) ABSTRACT

An embodiment in accordance with the present invention provides a device that is easily deployable on almost any style of door and prevents an intruder from opening the door. The device has a thin flat profile that is easily slid under a door and is also easily stored. The device includes a portion that engages the floor and the door to prevent the door from opening. The geometry of the portion that engages the floor and the door is such that the upward force on the door is increased when the door is either pushed or pulled. The harder an intruder pushes or pulls on the door, the more the device will grip both the door and floor itself. The device also includes a kickstand to keep the device in place and allow for easy removal.

### CROSS REFERENCE TO RELATED APPLICATIONS

This application claims the benefit of U.S. Provisional Patent Application No. 62/502,877 filed on May 8, 2017, which is incorporated by reference, herein, in its entirety.

### FIELD OF THE INVENTION

The present invention relates generally to safety equipment. More particularly, the present invention relates to a door barricade to prevent movement of a door in an emergency.

### BACKGROUND OF THE INVENTION

Door barricades are used to keep doors closed in case of an emergency, such as an active shooter situation or other security breach. In such an instance, it is important to have a way to barricade the door that is easy to use and can be deployed quickly. Many of the currently available door barricade devices are difficult to deploy or require pre-installation of part or all of the device. Pre-installation of a door barricade device may be more costly or time consuming than many organizations or businesses could bear. In other instances, installation of door barricade devices could be budgeted for months or years in the future.

Therefore, it would be advantageous to provide a door barricade that is cost effective and easy to install for use in case of emergency.

### SUMMARY OF THE INVENTION

The foregoing needs are met, to a great extent, by the present invention, wherein in one aspect a device for barricading a door includes an under-door portion. The under-door portion defines a door gap configured to accommodate a width of the door. The under-door portion comprises floor-engaging teeth configured to grip the floor under the door. The device also includes a securement lever comprising a handle and a kickstand, wherein the securement lever is rotationally coupled to the under-door portion, such that the securement lever is rotated to engage the under-door portion perpendicular to the floor.

In accordance with an aspect of the present invention, the under-door portion and the securement lever are formed from mild steel. The door-gap defines angles of 80°. The device is configured to work with a gap between the floor and a bottom surface of the door of a maximum of 0.7 inches. The device is configured to further engage the floor if the door is pushed or pulled after the device is engaged.

In accordance with another aspect of the present invention, the under-door portion includes a geometry that engages the floor and the door, such that an upward force on the door is increased when the door is either pushed or pulled. The kickstand is configured to keep the device in place. The kickstand is configured to allow for removal of the device. The securement lever is coupled to the under-door portion at a pivot point. The pivot point includes a coupling wherein the coupling is one selected from a group consisting of a screw, a snap-fit coupling, or a pressure-fit coupling. The pivot point is configured to allow for rotation between the under-door portion and the securement lever. The coupling can be smooth or threaded. The coupling includes stops to prevent the securement lever from rotating too far to provide a good grip on the floor. The kickstand includes floor-engaging teeth. The floor-engaging teeth of the under door portion and the kickstand are configured to grip a flooring surface. The flooring surface can take the form of one selected from a group consisting of tile, linoleum, wood, concrete, and carpet. The device is formed from a metal. The device is formed by stamping, milling, or three-dimensional printing. The securement lever includes a textured grip. The securement lever is coated with a material suitable for providing a grip.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates a perspective view of a device for barricading a door, according to an embodiment of the present invention.

FIG. 2 illustrates a side view of a device for barricading a door, according to an embodiment of the present invention.

FIG. 3 illustrates an edge view of a device for barricading a door, according to an embodiment of the present invention.

FIGS. 4-6 illustrate perspective views of a device for barricading a door being inserted under a door for use, according to an embodiment of the present invention.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

An embodiment in accordance with the present invention provides a device that is easily deployable on almost any style of door and prevents an intruder from opening the door. The device has a thin flat profile that is easily slid under a door and is also easily stored. The device includes a portion that engages the floor and the door to prevent the door from opening. The geometry of the portion that engages the floor and the door is such that the upward force on the door is increased when the door is either pushed or pulled. The harder an intruder pushes or pulls on the door, the more the device will grip both the door and floor itself. The device also includes a kickstand to keep the device in place and allow for easy removal.

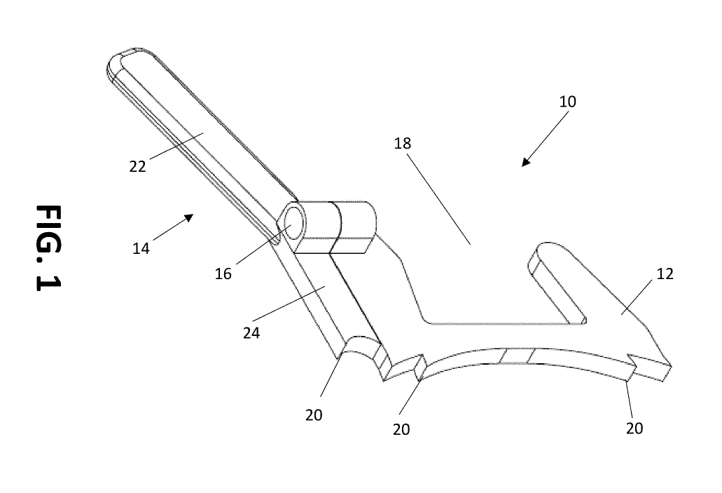

FIG. 1 illustrates a perspective view of a device for barricading a door, according to an embodiment of the present invention. As illustrated in FIG. 1, the device for barricading a door 10 includes an under-door portion 12 and a securement lever 14. The securement lever 14 is coupled to the under-door portion 12 at pivot point 16. The under-door portion 12 defines a door gap 18. The door gap 18 is sized to fit any standard door. The under-door portion 12 surrounding the door gap 18 defines angles, which will be described further herein. The under-door portion 12 also defines floor engagement teeth 20. The floor engagement teeth 20 are designed to grip the floor when the device for barricading a door 10 is fully deployed under a door. The securement lever 14 includes a handle 22 and a kickstand 24 that pivot about the pivot point 16. The kickstand 24 can include floor engagement teeth 20 that are configured to grip the floor and hold the device 10 in place. The floor engagement teeth 20 are configured to grip any typical flooring surface including but not limited to, tile, linoleum, wood, and carpet. The device 10 can also be used with a door having a threshold or other type of floor plate. Preferably, the device for barricading a door is formed from a metal, such as mild steel. Alternately, the device for barricading a door can be formed from any other suitable material known to or conceivable to one of skill in the art. The device for barricading a door can be stamped, milled, three-dimensionally printed or any other suitable fabrication process known to or conceivable by one of skill in the art.

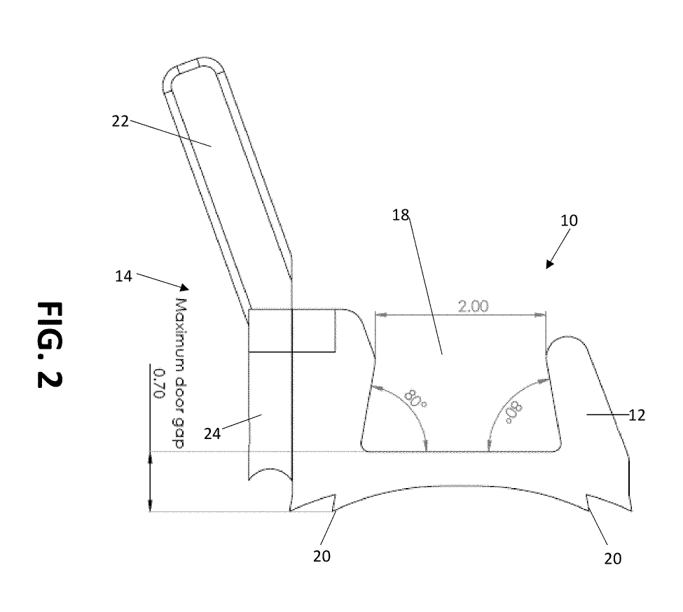

FIG. 2 illustrates a side view of a device for barricading a door, according to an embodiment of the present invention. The device for barricading a door 10 illustrated in FIG. 2 shows the door gap 18 defined by the under-door portion 12. In a preferred embodiment, the under-door portion 12 defines angles of approximately 80° between the bottom and the sides of the under door portion. These angles cause the device 10 to grip the floor with more force via the floor engagement teeth, when the door is pushed or pulled. In other words, if someone tries to breach the door once the device 10 is in place the device grips the floor and holds the door in place even more. Because, when the door is pushed or pulled after the device 10 is deployed, force is applied to the sides of the under-door portion 12 and the floor engagement teeth 20 are further pressed into the floor. Preferably, the maximum gap between the floor and the bottom of the door is approximately 0.70 inches. Other sized gaps between the bottom of the door and the floor could however be accommodated and are considered to be included within the scope of the present invention. The device is of a thickness such that it is sturdy, but can also fit through a wide variety of gaps between the bottom of the door and the floor. Any suitable dimensions known to or conceivable by one of skill in the art can be used.

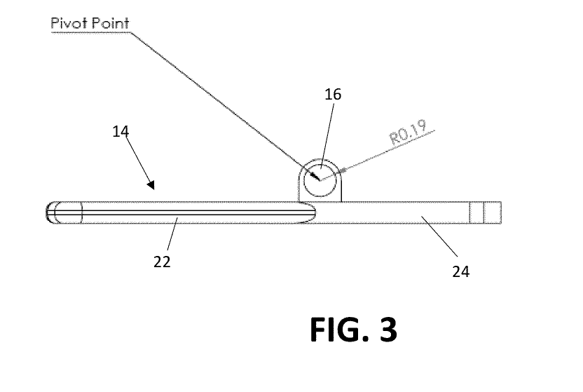

FIG. 3 illustrates an edge view of a device for barricading a door, according to an embodiment of the present invention. FIG. 3 illustrates the securement lever 14 and the pivot point 16. The pivot point 16 is the coupling between the securement lever 14 and the under-door portion 12. This coupling can take the form of a screw, snap-fit coupling, pressure-fit coupling, or other form of coupling known to or conceivable by one of skill in the art, so long as it allows for rotation between the securement lever 14 and the under-door portion 12. The coupling can be smooth, threaded, or can include stops to keep the securement lever from rotating too far to provide a good grip on the floor.

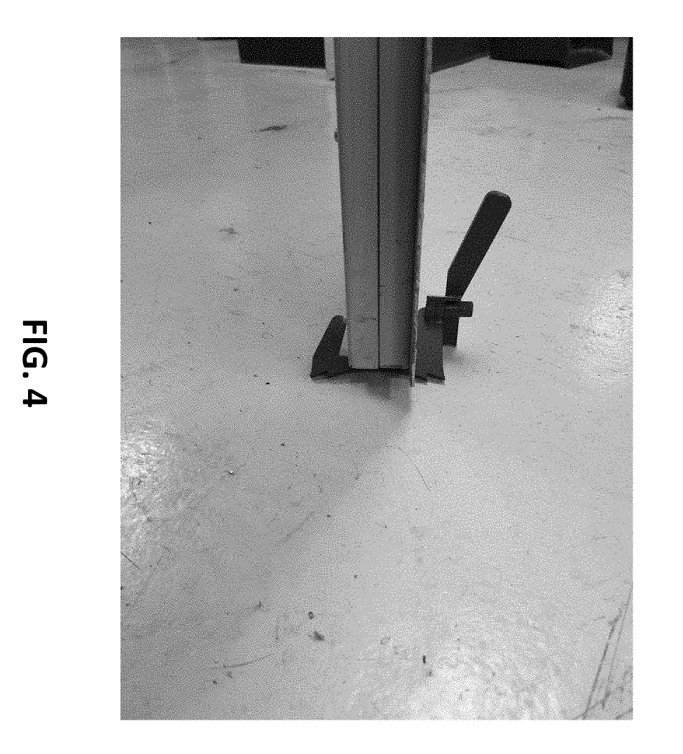

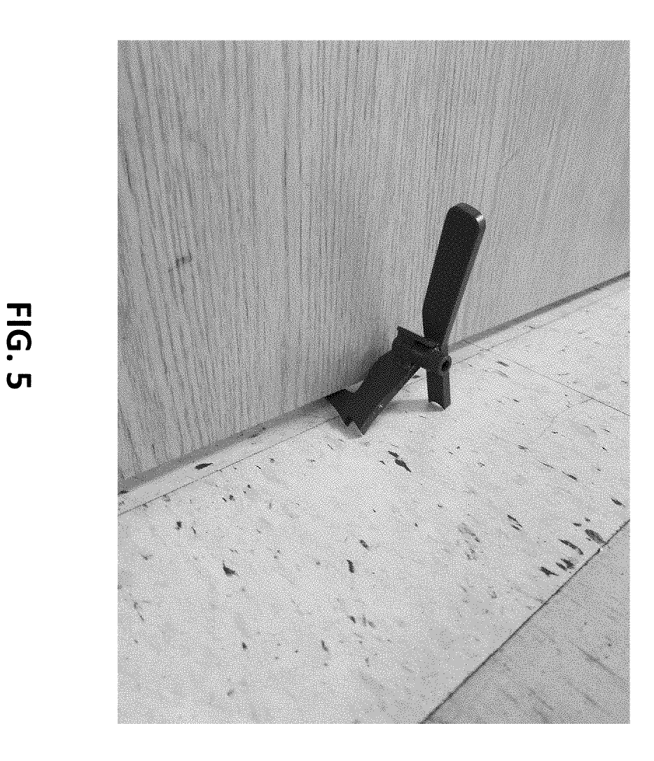

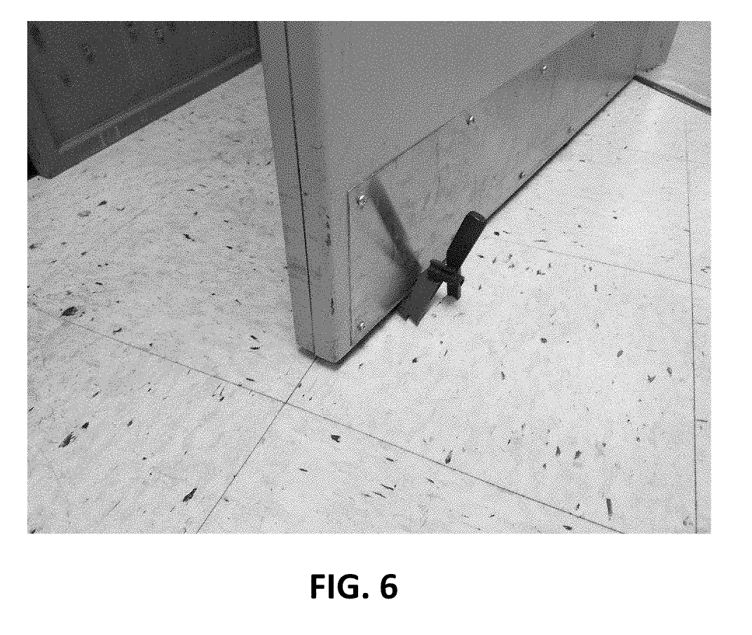

FIGS. 4-6 illustrate perspective views of a device for barricading a door being inserted under a door for use, according to an embodiment of the present invention. FIG. 4 illustrates the device for barricading a door inserted under a door, according to an embodiment of the present invention. FIGS. 5 and 6 illustrate the device for barricading the door being engaged under the door, such that the door cannot be moved. Once the device is positioned under the door, the securement lever is rotated in order to move the under-door portion from horizontal to vertical and to engage the under-door portion under the door and with the floor. The kickstand can also include floor engagement teeth so that the device is held in place, as described above. In some embodiments the securement lever can include a textured grip or a grip that is coated with a material such as rubber to make engaging the device with the floor easier for the user.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A device for barricading a door, comprising:
an under-door portion, wherein the under-door portion defines a door gap configured to accommodate a width of the door, and wherein the under-door portion comprises floor-engaging teeth configured to grip a floor under the door; and
a securement lever comprising a handle and a kickstand, wherein the securement lever is rotationally coupled to the under-door portion, such that the securement lever is rotated to engage the under-door portion perpendicular to the floor.

2. The device of claim 1 wherein the under-door portion and the securement lever are formed from mild steel.

3. The device of claim 1 wherein the door-gap defines angles of 80°.

4. The device of claim 1 wherein the device is configured to work with a gap between the floor and a bottom surface of the door of a maximum of 0.7 inches.

5. The device of claim 1, wherein the device is configured to further engage the floor if the door is pushed or pulled after the device is engaged.

6. The device of claim 1, wherein the under-door portion comprises a geometry that engages the floor and the door, such that an upward force on the door is increased when the door is either pushed or pulled.

7. The device of claim 1, wherein the kickstand is configured to keep the device in place.

8. The device of claim 1, wherein the kickstand is configured to allow for removal of the device.

9. The device of claim 1, wherein the securement lever is coupled to the under-door portion at a pivot point.

10. The device of claim 9, wherein the pivot point comprises a coupling wherein the coupling is one selected from a group consisting of a screw, a snap-fit coupling, or a pressure-fit coupling.

11. The device of claim 9, wherein the pivot point is configured to allow for rotation between the under-door portion and the securement lever.

12. The device of claim 10, wherein the coupling can be smooth or threaded.

13. The device of claim 10, wherein the coupling comprises stops to prevent the securement lever from rotating too far to provide a good grip on the floor.

14. The device of claim 1, wherein the kickstand comprises floor-engaging teeth.

15. The device of claim 14, wherein the floor-engaging teeth of the under door portion and the kickstand are configured to grip a flooring surface.

16. The device of claim 15, wherein the flooring surface consists of one selected from a group consisting of tile, linoleum, wood, concrete, and carpet.

17. The device of claim 1, wherein the device is formed from a metal.

18. The device of claim 1, wherein the device is formed by one selected from a group consisting of stamping, milling, and three-dimensional printing.

19. The device of claim 1, wherein the securement lever comprises a textured grip.

20. The device of claim 1 wherein the securement lever is coated with a material suitable for providing a grip.
